(19) United States
(12) Patent Application Publication
(10) Pub. No.: US 2023/0076967 A1
(43) Pub. Date: Mar. 9, 2023

(54) AUTOMATIC OPTIMIZATION METHOD AND AUTOMATIC OPTIMIZATION SYSTEM OF DIAGNOSIS MODEL

(71) Applicant: INSTITUTE FOR INFORMATION INDUSTRY, Taipei City (TW)

(72) Inventors: CI-YI LAI, TAIPEI CITY (TW); CHENG-HUI CHEN, TAIPEI CITY (TW); HSAIO-YU WANG, TAIPEI CITY (TW); HUAI-CHE HONG, TAIPEI CITY (TW)

(21) Appl. No.: 17/506,798

(22) Filed: Oct. 21, 2021

(30) Foreign Application Priority Data
Sep. 6, 2021 (TW) 110132950

(51) Int. Cl. G06N 3/12; G06N 3/08; G05B 13/02; G05B 13/04

(52) U.S. Cl. CPC G06N 3/126; G06N 3/08; G05B 13/0265; G05B 13/041

(57) ABSTRACT

An automatic optimization method and an automatic optimization system of a diagnosis model are provided. The automatic optimization method includes: obtaining equipment parameters; selecting a target model; selecting and converting a hyperparameter into a gene sequence, randomly generating a plurality of gene sequences to be optimized and adding them to a gene sequence set; performing a gene evolution process to generate a plurality of progeny gene sequences; performing a region search process on the plurality of progeny gene sequences to generate a plurality of new progeny gene sequences and add them to the gene sequence set; and in response to meeting the evolution completion condition, using the gene sequence set as an optimal gene sequence set for configuration of the target model and generation of a plurality of candidate diagnosis models.

### CROSS-REFERENCE TO RELATED PATENT APPLICATION

This application claims the benefit of priority to Taiwan Patent Application No. 110132950, filed on Sep. 6, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an optimization method and an optimization system, and more particularly to an automatic optimization method and an automatic optimization system of a diagnosis model.

### BACKGROUND OF THE DISCLOSURE

With the development of machine learning technology, industries begin to use machine learning technology to replace human labor, so as to speed up work progress and save labor costs. When a diagnosis model using artificial intelligence is being built, if a diagnosis is to be performed on a manufacturing equipment (such as a die-casting machine), vibration signals can be used to diagnose health of the die-casting machine.

However, pre-processing of data required for building the diagnosis model can only be achieved through cooperation of equipment technicians and data engineers with high professional experience. This process is not only time-consuming, but also requires additional human resources to adjust various hyperparameters in the diagnosis model.

Furthermore, adjustments of the hyperparameters require a large amount of computing resources, and the conventional diagnosis models for evaluating machine health are not capable of simultaneously evaluating computing costs. Therefore, under the condition of limited resources, there is difficulty in performing cost assessments before establishing the diagnosis model.

### SUMMARY OF THE DISCLOSURE

In response to the above-referenced technical inadequacies, the present disclosure provides an automatic optimization method and an automatic optimization system of a diagnosis model that can reduce costs of tuning parameters.

In one aspect, the present disclosure provides an automatic optimization method of a diagnosis model, the automatic optimization method includes: obtaining a plurality of equipment parameters of a target equipment; selecting a target model to be used for diagnosing an operation state of the target equipment from a plurality of candidate models, in which the target model has a plurality of hyperparameters; selecting at least one hyperparameter from the plurality of hyperparameters, and converting the at least one hyperparameter that is selected into a gene sequence; according to the at least one hyperparameter and the gene sequence, randomly generating a plurality of gene sequences to be optimized, and adding the plurality of gene sequences to be optimized to a gene sequence set; performing a genetic evolution process to configure the target model with the gene sequence set and perform training, and to optimally select a portion of the gene sequence set according to a training result, so as to breed a plurality progeny gene sequences; performing, for each of the plurality of progeny gene sequences, a region search process to find a plurality neighboring solutions, configure the target model to generate a plurality of models to be searched, train the plurality of models to be searched, and perform an optimal selection to obtain one of a plurality of new progeny gene sequences; adding the plurality of the new progeny gene sequences respectively generated by performing the region search process on the plurality of progeny gene sequences into the gene sequence set; filtering the gene sequence set to obtain a plurality of filtered gene sequences with higher accuracies; determining whether the gene sequence set meets an evolution completion condition, and using the gene sequence set that meets the evolution completion condition as an optimal gene sequence set; and configuring the target model with the optimal gene sequence set to generate a plurality of candidate diagnosis models.

In another aspect, the present disclosure provides an automatic optimization system of a diagnosis model, and the automatic optimization system includes a target equipment and a computing device. The target equipment is configured to generate a plurality of equipment parameters. The computing device includes a processor and a storage, and the processor is configured to obtain the plurality of equipment parameters and store the plurality of equipment parameters in the storage. The processor is configured to: select a target model to be used for diagnosing an operation state of the target equipment from a plurality of candidate models stored in the storage, in which the target model has a plurality of hyperparameters; select at least one hyperparameter from the plurality of hyperparameters, and converting the at least one hyperparameter that is selected into a gene sequence; according to the at least one hyperparameter and the gene sequence, randomly generate a plurality of gene sequences to be optimized, and add the plurality of gene sequences to be optimized to a gene sequence set; perform a genetic evolution process to configure the target model with the gene sequence set and perform training, and to optimally select a portion of the gene sequence set according to a training result, so as to breed a plurality progeny gene sequences; perform, for each of the plurality of progeny gene sequences, a region search process to find a plurality neighboring solutions, configure the target model to generate a plurality of models to be searched, train the plurality of models to be searched, and perform an optimal selection to obtain one of a plurality of new progeny gene sequences; add the plurality of new progeny gene sequences respectively generated by performing the region search process on the plurality of progeny gene sequences into the gene sequence set; filter the gene sequence set to obtain a plurality of filtered gene sequences with higher accuracies; determine whether the gene sequence set meets an evolution completion condition, use the gene sequence set that meets the evolution completion condition as an optimal gene sequence set, and store the optimal gene sequence in the storage; and configure the target model with the optimal gene sequence set to generate a plurality of candidate diagnosis models, and store the plurality of candidate diagnosis models in the storage.

Therefore, in the automatic optimization system and the automatic optimization method of the diagnosis model provided by the present disclosure, the genetic evolution process and the region search mechanism are utilized, which can automatically train artificial intelligence models and can test and verify all possible combinations of all the hyperparameters without spending lots of manpower and costs. Under the condition of limited resources, an optimal hyperparameter combination can be obtained. In addition, dependencies on data scientists can be reduced, and the saved manpower and costs can be used for data insights.

Furthermore, in the automatic optimization system and the automatic optimization method of the diagnosis model provided by the present disclosure, an efficiency frontier line is further generated. According to computing costs and memory limitations, a variety of combinations can be provided for a user's reference, so as to assist the user in selecting the most suitable diagnosis model based on their needs. In this way, cost assessments can be performed before establishing the diagnosis model.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of an automatic optimization system according to one embodiment of the present disclosure;

FIG. 2 is a functional block diagram of a computing device according to one embodiment of the present disclosure;

FIG. 3 is a flowchart of an automatic optimization method of a diagnosis model according to one embodiment of the present disclosure;

FIG. 4 is a flowchart illustrating conversion of a hyperparameter into a gene sequence according to one embodiment of the present disclosure;

FIG. 5 is a schematic diagram showing the hyperparameter being converted into the gene sequence according to one embodiment of the present disclosure;

FIG. 6 is a flowchart of a genetic evolution process according to one embodiment of the present disclosure;

FIG. 7 is a schematic diagram showing breeding and mutation in the genetic evolution process according to one embodiment of the present disclosure;

FIG. 8 is a flowchart of a region search process according to one embodiment of the present disclosure;

FIG. 9 is a schematic diagram of the region search process according to one embodiment of the present disclosure; and

FIG. 10 is a graph showing computing times versus computing costs with an efficiency frontier line according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

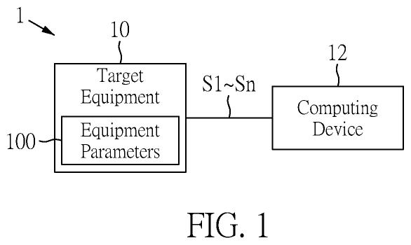

FIG. 1 is a functional block diagram of an automatic optimization system according to one embodiment of the present disclosure. Reference is made to FIG. 1, one embodiment of the present disclosure provides an automatic optimization system 1 of a diagnosis model, and the automatic optimization system 1 includes a target equipment 10 and a computing device 12.

The target equipment 10 can be, for example, a manufacturing equipment, and is configured to generate a plurality of equipment parameters 100. The target equipment 10 can be communicatively connected to the computing device 12, so as to transmit the plurality of equipment parameters 100 to the computing device 12 through a plurality of equipment signals S1 to Sn. The equipment signals S1 to Sn can be transmitted to the computing device 12 through interfaces that support various communication protocols, such as an interface that supports open platform communications unified architecture (OPC UA) protocol and/or Modbus protocol. Or, the equipment signals S1 to Sn can be directly transmitted to the computing device 12 in a form of analog signals. The equipment parameters 100 can include, for example, a plurality of parameters used in an operation of the target equipment 10. If the target equipment 10 is exemplified as a die casting machine, the equipment parameters 100 can include, for example, a hydraulic fluid temperature, an injection pressure, a low-speed opening position, a high-speed opening position, a vibration signal, and the like.

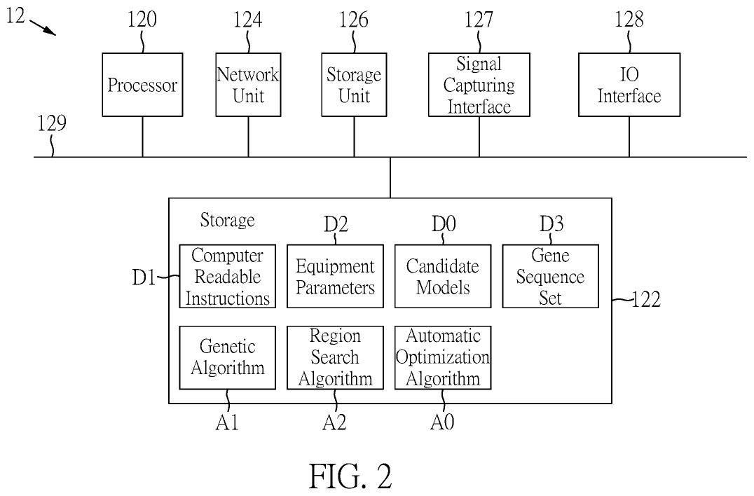

Reference is further made to FIG. 2, which is a functional block diagram of a computing device according to one embodiment of the present disclosure. Referring to FIG. 2, the computing device 12 can include a processor 120, a storage 122, a network unit 124, a storage unit 126, a signal capturing interface 127, and an input/output (IO) interface 128. The aforementioned components can communicate with one another through, for example, but not limited to, a bus 129.

The processor 120 is electrically coupled to the storage 122, and is configured to access computer-readable commands D1 from the storage 122, so as to control components in the computing device 12 to perform functions of the computing device 12.

The storage 122 is any storage device that can be used to store data, such as, but not limited to, a random-access memory (RAM), a read only memory (ROM), a flash memory, a hard disk or other storage devices that can be used to store data. The storage 122 is configured to at least store the plurality of computer readable instructions D1, a plurality of equipment parameters D2, a plurality of candidate models D0, a gene sequence set D3, an automatic optimization algorithm A0, a genetic algorithm A1, and a region search algorithm A2. In one embodiment, the storage 122 can also be used to store temporary data generated in response to the processor 120 performing operations.

The network unit 124 is configured to access the network under control of the processor 120 and can, for example, communicate with the target equipment 10. Alternatively, the target equipment 10 can also communicate with the computing device 12 through the signal capturing interface 127. In addition, the signal capturing interface 127 can, for example, support the aforementioned OPC UA protocol and Modbus protocol, or directly receive analog signals. Accordingly, the equipment signals S1 to Sn can be received, the equipment parameters 100 can be obtained, and the obtained equipment parameters 100 can be stored in the storage 122.

The storage unit 126 can be, for example, but not limited to a magnetic disk or an optical disk, so as to store data or instructions under the control of the processor 120. The JO interface 128 can be operated by a user to communicate with the processor 120 for data input and output.

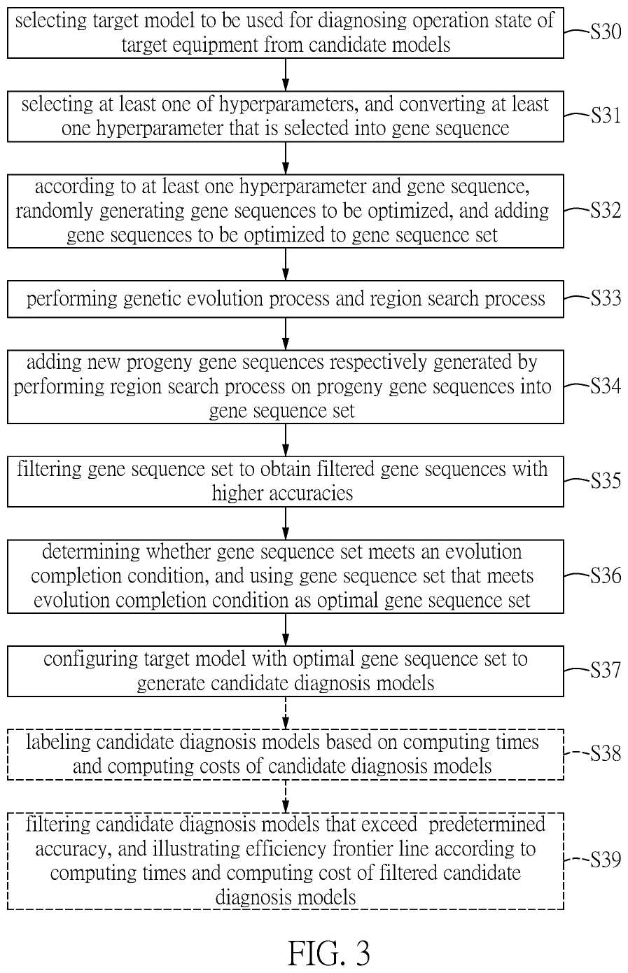

FIG. 3 is a flowchart of an automatic optimization method of a diagnosis model according to one embodiment of the present disclosure. In FIG. 3, an automatic optimization method of a diagnosis model is provided, which can be applied to the automatic optimization system 1 shown in FIG. 1. The automatic optimization method can also be embodied by other hardware components, such as databases, general processors, computers, servers, unique hardware devices with specific logic circuits, or equipment with specific functions (for example, a unique hardware integrating program codes and a processor/chip). In more detail, the automatic optimization method can be implemented by using a computer program to control components of the automatic optimization system 1. The computer program can be stored in a non-transitory computer-readable recording medium, such as a read-only memory, a flash memory, floppy disks, hard disks, optical disks, flash drives, tapes, databases that can be accessed over the Internet, or a computer-readable recording media with the same functions that can be easily achieved by those skilled in the arts.

Referring to FIG. 3, after the equipment parameters 100 of the target equipment 10 are obtained, the automatic optimization method of the diagnosis model can include configuring the processor 120 to execute the automatic optimization algorithm A0, so as to perform the following steps.

Step S30: selecting a target model to be used for diagnosing an operation state of the target equipment from a plurality of candidate models. The plurality of candidate models D0 can include, for example, a convolution neural network (CNN) model, an auto-encoder model, a random forest model, a long short-term memory (LSTM) model, or other artificial intelligence models that can be used to monitor the target equipment 1 for analyzing its operation state with a behavioral process analysis and performing a device state diagnosis.

In the aforementioned artificial intelligence model, there are a plurality of hyperparameters that can be adjusted by the user during a training process, so as to determine a growth curve of the artificial intelligence model. However, conventional ways used to adjust the hyperparameters are complicated and labor intensive, and rely too much on experiences of an adjuster. In general, the hyperparameters used by common artificial intelligence models (also used by the target model) can include, for example, a learning rate, an iteration, a dropout rate, a batch size, a feature selection, an activation function, and the like. In step S305, if the target model is selected as a CNN model, the hyperparameters further include an output size, a kernel size, a stride, a density, a padding and a pooling. In other words, different target models correspond to a plurality of different selectable hyperparameters.

Step S31: selecting at least one hyperparameter from the plurality of hyperparameters, and converting the at least one hyperparameter that is selected into a gene sequence.

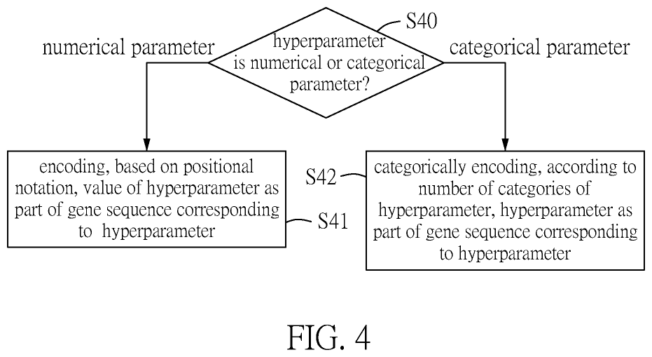

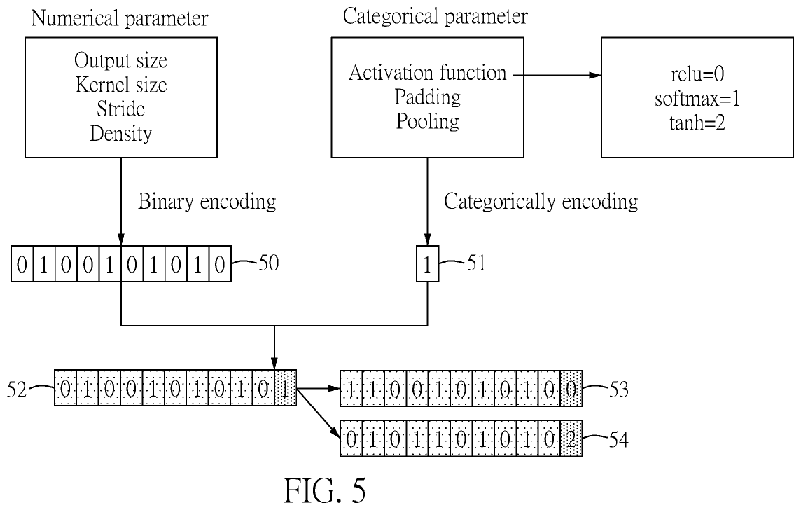

Reference can be further made to FIGS. 4 and 5. FIG. 4 is a flowchart illustrating conversion of a hyperparameter into a gene sequence according to one embodiment of the present disclosure, and FIG. 5 is a schematic diagram showing the hyperparameter being converted into the gene sequence according to one embodiment of the present disclosure.

As shown in FIG. 4, in the aforementioned step S31, the step of converting the at least one hyperparameter into the gene sequence includes:

Step S40: determining whether the at least one hyperparameter is a numerical parameter or a categorical parameter.

In response to determining that the at least one hyperparameter is the numerical parameter, step S41 is performed. Step S41: encoding, based on a positional notation, a value of the at least one hyperparameter as a part of the gene sequence corresponding to the at least one hyperparameter.

As shown in FIG. 5, when the target model is exemplified as a CNN model, the hyperparameters (such as the output size, the core size, the stride, and the density) are determined as the numerical parameters, and numerical values of the above hyperparameters can be encoded in binary form to generate a gene sequence 50. However, the present disclosure is not limited thereto. Other positional notations and other encoding methods can also be used to generate the gene sequence 50.

In response to determining that the at least one hyperparameter is the categorical parameter, step S42 is performed. Step S42: categorically encoding, according to a number of categories of the at least one hyperparameter, the at least one hyperparameter as a part of the gene sequence corresponding to the at least one hyperparameter.

Similarly, as shown in FIG. 5, when the target model is exemplified as the CNN model, the hyperparameters (such as the activation function, the padding and the pooling) are determined as the categorical parameters. For example, for the activation function, a ReLU function, a softmax function or a tanh function can be used. The ReLU function, the softmax function, or the tanh function is used to generate category codes 0, 1, and 2 according to the number of categories, so as to generate a gene sequence 51.

In addition, in step S31, if two or more than two of the hyperparameters are selected from the plurality of hyperparameters, the gene sequences 50 and 51 can be merged into a gene sequence 52 as shown in a lower part of FIG. 5, and an order of the combination thereof is not limited in the present disclosure.

Reference is made to FIG. 3 again. After step S31 is performed, the automatic optimization method proceeds to step S32: according to the at least one hyperparameter and the gene sequence, randomly generating a plurality of gene sequences to be optimized, and adding the plurality of gene sequences to be optimized to the gene sequence set D3.

For example, as shown in FIG. 5, after a structure of the gene sequence 52 is determined, multiple sets of gene sequences (such as gene sequences 53, 54) can be randomly generated according to the aforementioned encoding manners. The so-called “random generation” can refer to, for example, having any value of the numeric parameter and any categorical code of the categorical parameter randomly generated first, which can then be converted into a gene sequence, or having a specific range directly assigned to randomly generate a combined gene sequence. For example, ten different gene sequences can be randomly generated and added to the gene sequence set D3.

Step S33: performing a genetic evolution process and a region search process. The genetic evolution process configures and trains the target model based on the gene sequence set, and optimally selects, according to a training result, a portion of the gene sequence to breed a plurality of progeny gene sequences. For each of the plurality of progeny gene sequences, the regional search process is used to find a plurality of neighboring solutions, configure the target model to generate a plurality of models to be searched, train the plurality of models to be searched, and perform an optimal selection to obtain one of a plurality of new progeny gene sequences.

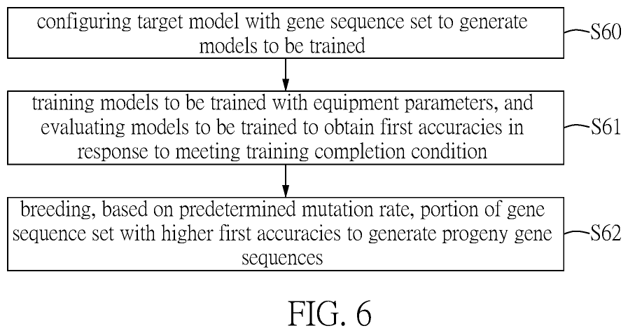

Reference is made to FIG. 6, which is a flowchart of a genetic evolution process according to one embodiment of the present disclosure. As shown in FIG. 6, the genetic evolution process can include configuring the processor 120 to execute the genetic algorithm A1, so as to perform the following steps.

Step S60: configuring the target model with the gene sequence set to generate a plurality of models to be trained. For example, ten sets of randomly generated gene sequences (including the selected hyperparameters and types or values defined by the gene sequences) can be applied to the target model (e.g., the CNN model).

Step S61: training the plurality of models to be trained with the plurality of equipment parameters, and evaluating the plurality of models to be trained to obtain a plurality of first accuracies in response to meeting a training completion condition.

In this step, the so-called “training” can include dividing the obtained equipment parameters D2 into a training set, a test set, and a verification set. The model can be adjusted based on the training set first, the adjusted model can then perform predictions based on the verification set, and the hyperparameters can be evaluated. The test set is used to evaluate the final model. For a diagnosis model to be used to evaluate an equipment state of the target equipment, training parameters need to include a labeled data set. For example, to generate a diagnosis model for evaluating health of the die casting machine, the data set must include at least the hydraulic fluid temperature, the injection pressure, the low-speed opening position, the high-speed opening position, the vibration signal, and corresponding health evaluation results.

In addition, during the training process of step S61, a plurality of first computing costs and a plurality of first computing times spent in training the plurality of models to be trained are calculated, respectively. The training completion condition is essentially a convergence condition, so as to avoid endless training. For example, whether the training completion condition is met can be determined by separately determining whether the plurality of first computing costs reach a predetermined computing cost, and determining whether the plurality of first computing times reach a predetermined computing time. For example, whether a duration of the training reaches 30 minutes, or whether a computing power of 30 US dollars is used up can be determined. In response to determining that the plurality of first computing costs reach the predetermined computing cost (e.g., 30 US dollars) or the plurality of first computing times reach the predetermined computing time (e.g., 30 minutes), the training completion condition is determined to have been met, and the plurality of first accuracies of the plurality of models to be trained are recorded.

Step S62: breeding, based on a predetermined mutation rate, the portion of the gene sequence set with the higher first accuracies to generate the plurality of progeny gene sequences.

For example, after the training is completed, the aforementioned plurality of first accuracies are ranked from high to low, and the top two gene sequences are bred with a mutation rate of 0.1%.

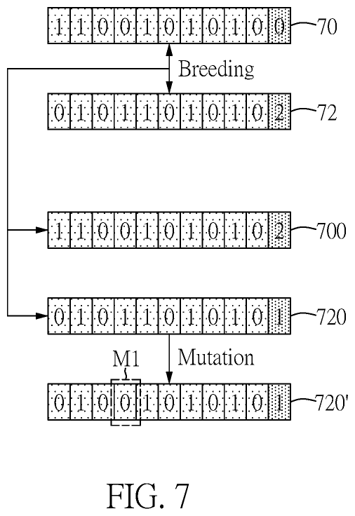

Reference is made to FIG. 7, which is a schematic diagram showing breeding and mutation in the genetic evolution process according to one embodiment of the present disclosure. As shown in FIG. 7, after gene sequences 70 and 72 with the higher first accuracies are bred, progeny gene sequences 700 and 720 are generated. A breeding mode can be, for example, having parts corresponding to different hyperparameters in the gene sequences 70 and 72 exchanged and combined. For example, ten numbers on the left correspond to the output size, and one number on the right corresponds to the activation function. If a mutation occurs during the breeding process based on the predetermined mutation rate, for example, if the progeny gene sequence 720 generated by the breeding has the mutation, one of the numbers in the progeny gene sequence 720 is modified. As shown in FIG. 7, a fourth binary number from the left in the progeny gene sequence 720 is modified as a mutant gene Ml, which is modified from 1 to 0 to generate a progeny gene sequence 720′. If the number is 0, said number can be modified to 1. However, the above are only examples, and manners, numbers, and locations of the mutations of the gene sequence are not limited in the present disclosure.

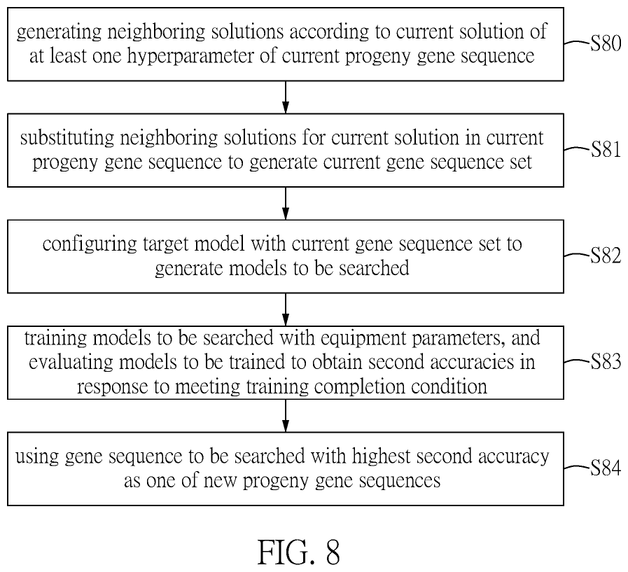

Reference is further made to FIG. 8, which is a flowchart of a region search process according to one embodiment of the present disclosure. As shown in FIG. 8, the region search process can include configuring the processor 120 to execute the region search algorithm A2, so as to perform the following steps.

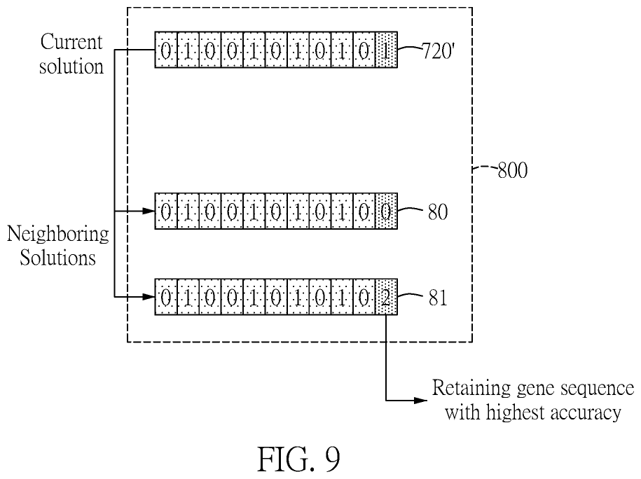

Step S80: generating the plurality of neighboring solutions according to a current solution of the at least one hyperparameter of a current progeny gene sequence. Reference can be made to FIG. 9, which is a schematic diagram of the region search process according to one embodiment of the present disclosure. For example, if the progeny gene sequence 720′ of FIG. 7 is taken as the current progeny gene sequence in FIG. 9, a current solution corresponding to the activation function is 1, and the code thereof corresponds to the softmax function shown in FIG. 5. In other words, the neighboring solutions of the current solution are 0 and 2, which correspond to the ReLU function and the tanh function, respectively.

Step S81: substituting the plurality of neighboring solutions for the current solution in the current progeny gene sequence to generate a current gene sequence set. For example, as shown in FIG. 9, if the neighboring solutions are known to be 0 and 2, then these neighboring solutions are used to replace the current solution (i.e., 1) in the progeny gene sequence 720′, so as to generate progeny gene sequences 80 and 81. The progeny gene sequences 720′, 80, and 81 can be further taken as a current gene sequence set 800, which includes a plurality of gene sequences to be searched corresponding to the current solution (i.e., 1) and the neighboring solutions (i.e., 0, 2), that is, the progeny gene sequences 720′, 80 and 81.

Step S82: configuring the target model with the current gene sequence set to generate the plurality of models to be searched. This step is similar to step S60, and the current gene sequence set (including the progeny gene sequences 720′, 80, 81) is applied to the target model (for example, the CNN model) to generate the plurality of models to be searched.

Step S83: training the plurality of models to be searched with the plurality of equipment parameters, and evaluating the plurality of models to be trained to obtain a plurality of second accuracies in response to meeting the training completion condition.

During the training process of step S83, a plurality of second computing costs and a plurality of second computing times spent in training the plurality of models to be searched are calculated, respectively. For example, whether the training completion condition is met can be determined by separately determining whether the plurality of second computing costs reach the predetermined computing cost, and determining whether the plurality of second computing times reach the predetermined computing time. For example, whether a duration of the training reaches 30 minutes, or whether a computing power of 30 US dollars is used up can be determined. In response to determining that the plurality of second computing costs reach the predetermined computing cost (e.g., 30 US dollars) or the plurality of second computing times reach the predetermined computing time (e.g., 30 minutes), the training completion condition is determined to have been met, and the plurality of second accuracies of the plurality of models to be searched are recorded.

Step S84: using the gene sequence to be searched with the highest second accuracy as the one of the plurality of new progeny gene sequences. In this step, the second accuracies of the plurality of models to be searched are ranked, and the original progeny gene sequence is replaced by that with a maximum accuracy. For example, as shown in FIG. 8, if the second accuracy of the progeny gene sequence 81 is higher than that of the progeny gene sequence 720′, the progeny gene sequence 81 is used as the one of the plurality of new progeny gene sequences.

Reference is made to FIG. 3 again, and the automatic optimization method further includes the following steps.

Step S34: adding the plurality of new progeny gene sequences respectively generated by performing the region search process on the plurality of progeny gene sequences into the gene sequence set.

Step S35: filtering the gene sequence set to obtain a plurality of filtered gene sequences with higher accuracies. For example, in each round of evolution, only ten gene sequences with the top ten accuracies can be left and enter the next round of evolution.

Step S36: determining whether the gene sequence set meets an evolution completion condition, and using the gene sequence set that meets the evolution completion condition as an optimal gene sequence set.

In detail, the evolution completion condition is also a convergence condition. For example, whether the gene sequence set meets the evolution completion condition can be determined by, after the gene evolution process and the region search process are performed for multiple times, determining whether a number of times of not improving the maximum accuracy achieved by all the progeny gene sequences in the gene sequence set D3 exceeds a predetermined number of times. For example, in response to the maximum accuracy failing to reach a new high in recent ten or more evolutionary generations, the evolution completion condition is determined to have been met, and the gene sequence set D3 at this time is taken as an optimal gene sequence set.

Therefore, in the present disclosure, by utilizing the genetic evolution process and the region search mechanism, artificial intelligence models can be automatically trained, and all possible combinations of all the hyperparameters can be tested and verified without spending lots of manpower and costs. In this way, under the condition of limited resources, an optimal hyperparameter combination can be obtained.

Step S37: configuring the target model with the optimal gene sequence set to generate a plurality of candidate diagnosis models. This step is used to configure the target model based on a plurality of gene sequences in the optimal gene sequence set, which is similar to step S60 and will not be reiterated herein. The generated plurality of candidate diagnosis models can be provided to the user for selection.

In addition, a basis for the user's selection needs to be further provided. In other words, the user needs to select the most suitable diagnosis model for their needs based on the computing time or computing cost of the plurality of candidate diagnosis models. Therefore, as shown in FIG. 3, the automatic optimization method can optionally further include the following steps.

Step S38: labeling the plurality of candidate diagnosis models based on a plurality of computing times and a plurality of computing costs of the plurality of candidate diagnosis models.

Step S39: filtering the candidate diagnosis models that exceed a predetermined accuracy, and illustrating an efficiency frontier line according to the computing times and the computing cost of the filtered candidate diagnosis models.

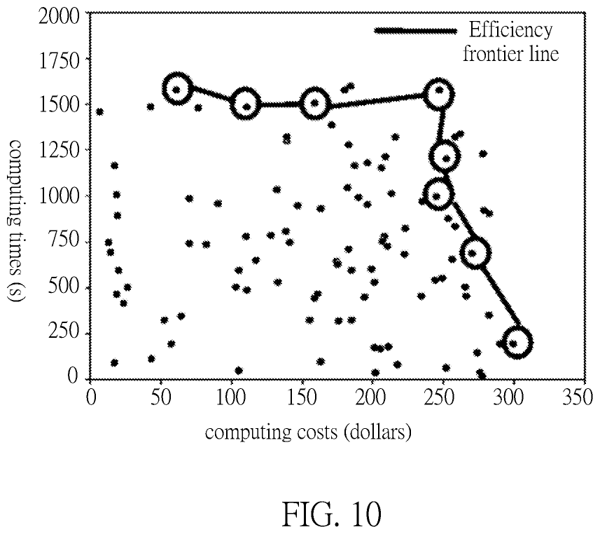

Reference is made to FIG. 10, which is a graph showing computing times versus computing costs with an efficiency frontier line according to one embodiment of the present disclosure. As shown in FIG. 10, in the optimal gene sequence set, the computing times and computing costs (computing power) spent in the training process are recorded for all the candidate diagnosis models corresponding to the gene sequences. Therefore, after the computing times and the computing costs of the candidate diagnosis models are labeled, the efficiency frontier line can be drawn for these candidate diagnosis models with accuracies more than 80%. The above are only examples, and the present disclosure is not limited thereto.

Therefore, according to computing costs and memory limitations, this efficiency frontier line can provide a variety of combinations for the user's reference, so as to assist the user in selecting the most suitable diagnosis model based on their needs. In this way, cost assessments can be performed before establishing the diagnosis model.

In conclusion, in the automatic optimization system and the automatic optimization method of the diagnosis model provided by the present disclosure, the genetic evolution process and the region search mechanism are utilized, which can automatically train artificial intelligence models and can test and verify all possible combinations of all the hyperparameters without spending lots of manpower and costs. Under the condition of limited resources, an optimal hyperparameter combination can be obtained. In addition, dependencies on data scientists can be reduced, and the saved manpower and costs can be used for data insights.

Furthermore, in the automatic optimization system and the automatic optimization method of the diagnosis model provided by the present disclosure, an efficiency frontier line is further generated. According to computing costs and memory limitations, a variety of combinations can be provided for a user's reference, so as to assist the user in selecting the most suitable diagnosis model based on their needs. In this way, cost assessments can be performed before establishing the diagnosis model.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An automatic optimization method of a diagnosis model, the automatic optimization method comprising:
obtaining a plurality of equipment parameters of a target equipment;
selecting a target model to be used for diagnosing an operation state of the target equipment from a plurality of candidate models, wherein the target model has a plurality of hyperparameters;
selecting at least one hyperparameter from the plurality of hyperparameters, and converting the at least one hyperparameter that is selected into a gene sequence;
according to the at least one hyperparameter and the gene sequence, randomly generating a plurality of gene sequences to be optimized, and adding the plurality of gene sequences to be optimized to a gene sequence set;
performing a genetic evolution process to configure the target model with the gene sequence set and perform training, and to optimally select a portion of the gene sequence set according to a training result, so as to breed a plurality of progeny gene sequences;
performing, for each of the plurality of progeny gene sequences, a region search process to:
find a plurality of neighboring solutions;
configure the target model to generate a plurality of models to be searched;
train the plurality of models to be searched; and
perform an optimal selection to obtain one of a plurality of new progeny gene sequences;
adding the plurality of new progeny gene sequences respectively generated by performing the region search process on the plurality of progeny gene sequences into the gene sequence set;
filtering the gene sequence set to obtain a plurality of filtered gene sequences with higher accuracies;
determining whether the gene sequence set meets an evolution completion condition, and using the gene sequence set that meets the evolution completion condition as an optimal gene sequence set; and
configuring the target model with the optimal gene sequence set to generate a plurality of candidate diagnosis models.

2. The automatic optimization method according to claim 1, wherein the genetic evolution process includes:
configuring the target model with the gene sequence set to generate a plurality of models to be trained;
training the plurality of models to be trained with the plurality of equipment parameters, and evaluating the plurality of models to be trained to obtain a plurality of first accuracies in response to meeting a training completion condition; and
breeding, based on a predetermined mutation rate, the portion of the gene sequence set with the higher first accuracies to generate the plurality of progeny gene sequences.

3. The automatic optimization method according to claim 2, wherein the region search process includes:
generating the plurality of neighboring solutions according to a current solution of the at least one hyperparameter of a current progeny gene sequence;
substituting the plurality of neighboring solutions for the current solution in the current progeny gene sequence to generate a current gene sequence set, wherein the current gene sequence set includes a plurality of gene sequences to be searched corresponding to the current solution and the plurality of neighboring solutions;
configuring the target model with the current gene sequence set to generate the plurality of models to be searched;
training the plurality of models to be searched with the plurality of equipment parameters, and evaluating the plurality of models to be searched to obtain a plurality of second accuracies in response to meeting the training completion condition; and
using the gene sequence to be searched with the highest second accuracy as the new progeny gene sequence.

4. The automatic optimization method according to claim 1, wherein the step of converting the at least one hyperparameter into the gene sequence includes:
determining whether the at least one hyperparameter is a numerical parameter or a categorical parameter;
in response to determining that the at least one hyperparameter is the numerical parameter, encoding, based on a positional notation, a value of the at least one hyperparameter as a part of the gene sequence corresponding to the at least one hyperparameter; and
in response to determining that the at least one hyperparameter is the categorical parameter, categorically encoding, according to a number of categories of the at least one hyperparameter, the at least one hyperparameter as a part of the gene sequence corresponding to the at least one hyperparameter.

5. The automatic optimization method according to claim 3, wherein a step of breeding the portion of the gene sequence set using the predetermined mutation rate to generate the plurality of progeny gene sequences further includes:
in response to breeding the portion of the gene sequence set based on the predetermined mutation rate and having an occurrence of a mutation, modifying one of numbers in the progeny gene sequence generated by the breeding and the mutation.

6. The automatic optimization method according to claim 3, wherein a step of training the plurality of models to be trained with the plurality of equipment parameters, and evaluating the plurality of models to be trained to obtain the plurality of first accuracies in response to meeting the training completion condition further includes:
respectively calculating a plurality of first computing costs and a plurality of first computing times spent in training the plurality of models to be trained, wherein determining whether the training completion condition is met further includes separately determining whether the plurality of first computing costs reach a predetermined computing cost, and determining whether the plurality of first computing times reach a predetermined computing time; and
in response to determining that the plurality of first computing costs reach the predetermined computing cost, or the plurality of first computing times reach the predetermined computing time, determining that the training completion condition is met.

7. The automatic optimization method according to claim 6, wherein a step of training the plurality of models to be searched with the plurality of equipment parameters, and evaluating the plurality of models to be searched to obtain the plurality of second accuracies in response to meeting the training completion condition further includes:
respectively calculating a plurality of second computing costs and a plurality of second computing times spent in training the plurality of models to be trained, wherein determining whether the training completion condition is met further includes separately determining whether the plurality of second computing costs reach the predetermined computing cost, and determining whether the plurality of second computing times reach the predetermined computing time; and
in response to determining that the plurality of second computing costs reach the predetermined computing cost, or the plurality of second computing times reach the predetermined computing time, determining that the training completion condition is met.

8. The automatic optimization method according to claim 7, further comprising:
labeling the plurality of candidate diagnosis models based on a plurality of computing times and a plurality of computing costs of the plurality of candidate diagnosis models; and
filtering the candidate diagnosis models that exceed a predetermined accuracy, and illustrating an efficiency frontier line according to the computing times and the computing cost of the filtered candidate diagnosis models.

9. The automatic optimization method according to claim 3, wherein a step of determining whether the evolution completion condition is met further includes:
determining, after the gene evolution process is performed, whether a number of times of not improving a maximum accuracy achieved by the gene sequence set exceeds a predetermined number of times; and
in response to determining that the number of times of not improving the maximum accuracy exceeds the predetermined number of times, determining that the evolution completion condition is met.

10. An automatic optimization system of a diagnosis model, the automatic optimization system comprising:
a target equipment configured to generate a plurality of equipment parameters;
a computing device including a processor and a storage, wherein the processor is configured to obtain the plurality of equipment parameters and store the plurality of equipment parameters in the storage,
wherein the processor is configured to:
select a target model to be used for diagnosing an operation state of the target equipment from a plurality of candidate models stored in the storage, wherein the target model has a plurality of hyperparameters;
select at least one hyperparameter from the plurality of hyperparameters, and convert the at least one hyperparameter that is selected into a gene sequence;
according to the at least one hyperparameter and the gene sequence, randomly generate a plurality of gene sequences to be optimized, and add the plurality of gene sequences to be optimized to a gene sequence set;
perform a genetic evolution process to configure the target model with the gene sequence set and perform training, and to optimally select a portion of the gene sequence set according to a training result, so as to breed a plurality of progeny gene sequences;
perform, for each of the plurality of progeny gene sequences, a region search process to:
find a plurality of neighboring solutions;
configure the target model to generate a plurality of models to be searched;
train the plurality of models to be searched; and
perform an optimal selection to obtain one of a plurality of new progeny gene sequences;
add the plurality of new progeny gene sequences respectively generated by performing the region search process on the plurality of progeny gene sequences into the gene sequence set;
filter the gene sequence set to obtain a plurality of filtered gene sequences with higher accuracies;
determine whether the gene sequence set meets an evolution completion condition, use the gene sequence set that meets the evolution completion condition as an optimal gene sequence set, and store the optimal gene sequence in the storage; and
configure the target model with the optimal gene sequence set to generate a plurality of candidate diagnosis models, and store the plurality of candidate diagnosis models in the storage.

11. The automatic optimization system according to claim 10, wherein the genetic evolution process includes:
configuring the target model with the gene sequence set to generate a plurality of models to be trained;
training the plurality of models to be trained with the plurality of equipment parameters, and evaluating the plurality of models to be trained to obtain a plurality of first accuracies in response to meeting a training completion condition; and
breeding, based on a predetermined mutation rate, the portion of the gene sequence set with the higher first accuracies to generate the plurality of progeny gene sequences.

12. The automatic optimization system according to claim 11, wherein the region search process includes:
generating the plurality of neighboring solutions according to a current solution of the at least one hyperparameter of a current progeny gene sequence;
substituting the plurality of neighboring solutions for the current solution in the current progeny gene sequence to generate a current gene sequence set, wherein the current gene sequence set includes a plurality of gene sequences to be searched corresponding to the current solution and the plurality of neighboring solutions;
configuring the target model with the current gene sequence set to generate the plurality of models to be searched;
training the plurality of models to be searched with the plurality of equipment parameters, and evaluating the plurality of models to be searched to obtain a plurality of second accuracies in response to meeting the training completion condition; and
using the gene sequence to be searched with the highest second accuracy as the new progeny gene sequence.

13. The automatic optimization system according to claim 10, wherein, in the step that the processor converts the at least one hyperparameter into the gene sequence, the processor is further configured to:
determine whether the at least one hyperparameter is a numerical parameter or a categorical parameter;
in response to determining that the at least one hyperparameter is the numerical parameter, encode, based on a positional notation, a value of the at least one hyperparameter as a part of the gene sequence corresponding to the at least one hyperparameter; and
in response to determining that the at least one hyperparameter is the categorical parameter, categorically encode, according to a number of categories of the at least one hyperparameter, the at least one hyperparameter as a part of the gene sequence corresponding to the at least one hyperparameter.

14. The automatic optimization system according to claim 12, wherein a step of breeding the portion of the gene sequence set using the predetermined mutation rate to generate the plurality of progeny gene sequences further includes:
in response to breeding the portion of the gene sequence set based on the predetermined mutation rate and having an occurrence of a mutation, modifying one of numbers in the progeny gene sequence generated by the breeding and the mutation.

15. The automatic optimization system according to claim 12, wherein, in the step that the processor trains the plurality of models to be trained with the plurality of equipment parameters, and evaluates the plurality of models to be trained to obtain the plurality of first accuracies in response to meeting the training completion condition, the processor is further configured to:
respectively calculate a plurality of first computing costs and a plurality of first computing times spent in training the plurality of models to be trained, wherein determining whether the training completion condition is met further includes separately determining whether the plurality of first computing costs reach a predetermined computing cost, and determining whether the plurality of first computing times reach a predetermined computing time; and
in response to determining that the plurality of first computing costs reach the predetermined computing cost, or the plurality of first computing times reach the predetermined computing time, determine that the training completion condition is met.

16. The automatic optimization system according to claim 15, wherein, in a step that the processor trains the plurality of models to be searched with the plurality of equipment parameters, and evaluates the plurality of models to be searched to obtain the plurality of second accuracies in response to meeting the training completion condition, the processor is further configured to:
respectively calculate a plurality of second computing costs and a plurality of second computing times spent in training the plurality of models to be trained, wherein determining whether the training completion condition is met further includes separately determining whether the plurality of second computing costs reach the predetermined computing cost, and determining whether the plurality of second computing times reach the predetermined computing time; and
in response to determining that the plurality of second computing costs reach the predetermined computing cost, or the plurality of second computing times reach the predetermined computing time, determine that the training completion condition is met.

17. The automatic optimization system according to claim 16, wherein the processor is further configured to:
label the plurality of candidate diagnosis models based on a plurality of computing times and a plurality of computing costs of the plurality of candidate diagnosis models; and
filter the candidate diagnosis models that exceed a predetermined accuracy, and illustrate an efficiency frontier line according to the computing times and the computing cost of the filtered candidate diagnosis models.

18. The automatic optimization system according to claim 12, wherein, in a step that the processor determines whether the evolution completion condition is met, the processor is further configured to:
determine, after the gene evolution process is performed, whether a number of times of not improving a maximum accuracy achieved by the gene sequence set exceeds a predetermined number of times; and
in response to determining that the number of times of not improving the maximum accuracy exceeds the predetermined number of times, determine that the evolution completion condition is met.
